(19) United States
(12) Patent Application Publication
(10) Pub. No.: US 2007/0251106 A1
(43) Pub. Date: Nov. 1, 2007

(54) Connector and handle for credit card razor

(75) Inventor: Paul Gladstone, Worthing (GB)

Correspondence Address: LERNER, DAVID, LITTENBERG,;KRUMHOLZ & MENTLIK, 600 SOUTH AVENUE WEST, WESTFIELD, NJ, 07090, US

(73) Assignee: Americanino Limited, Worthing (GB)

(21) Appl. No.: 11/784,772

(22) Filed: Apr. 9, 2007

(30) Foreign Application Priority Data
Apr. 10, 2006 (GB) 0607201.1

(51) Int. Cl. B26B 21/00

(52) U.S. Cl. 30/526

(57) ABSTRACT

A connector with a first connection means on a first side and a second connection means on a second side, in which the first connection means is adapted to releasably connect to a credit card, or a card with substantially the same dimensions as a credit card, with which the connector is used, and in which the second connection means is adapted to releasably connect to a razor head with which the connector is used.

### BACKGROUND OF THE INVENTION

This invention relates to a connector and a handle, both of which facilitate the formation of a wet shave razor in which the handle is a credit card, or substantially dimensioned as such.

Wet shave razors either comprise an integral handle and razor head, or a handle with detachable razor heads. In each instance, the handles are commonly elongate in shape, and are dimensioned to fit into the hand. As such they consume a certain amount of space.

In some circumstances space is at a premium, in particular when travelling.

The elongate handles of the wet razors referred to above can be awkward to use for the infirm or the physically disabled, because they tend to have a narrow width which requires a certain level of digit dexterity to manipulate effectively. The correct manipulation of a wet shave razor is important if an efficient and safe shave is to be achieved.

Advertisers continuously search for new ways to advertise products or services, and in particular for new arenas in which to do so. One known way to promote a product or service is to give away information cards the size and shape of credit cards, such that they can be readily carried in a wallet or bag. However, such cards are often discarded as they serve no technical function.

### SUMMARY OF THE INVENTION

The present invention is intended to overcome some of the above problems.

Therefore, according to a first aspect of the present invention a connector is provided with a first connection means on a first side and a second connection means on a second side, in which the first connection means is adapted to releasably connect to a credit card, or a card with substantially the same dimensions as a credit card, with which the connector is used, and in which the second connection means is adapted to releasably connect to a razor head with which the connector is used.

(The term “credit card” used herein is intended to refer to the well known cards used for financial purposes which are constructed from a plastics material. It will be appreciated from the above Statement of Invention that the invention also includes any cards which have substantially similar physical characteristics to credit cards. Credit cards conform to standard outer dimensions, which are approximately 86 mm by 54 mm, and 0.5 mm thick. Where credit cards or their dimensions are mentioned herein, it is substantially these dimensions which are being referred to.)

Thus, the connector of the present invention facilitates the quick and easy creation of a wet shave razor, using only a razor head and a credit card. As such, the invention allows a functional and useful device to be formed in which the largest component is one which a user will in most circumstances carry in any case. Thus, there is no need to carry a wet razor handle when travelling, which could be potentially onerous if the user had no luggage and had to rely on pocket space.

In addition, the infirm or the disabled who suffer from reduced digit dexterity can in many cases manipulate a wet shave razor with a credit card for a handle more readily than known elongate handle constructions, due to a credit card's broad and flat shape.

Another advantage of the invention is that any indicia on the credit card used to make the wet shave razor will be visible to the user in use. Therefore, advertisers could provide credit card sized cards intended to be used in the manner described above, which carry advertising, wording or other indicia adapted to promote a particular message, product or service.

In a preferred construction the first connection element can comprise a body with an elongate slot formed therein, which is adapted to receive a first end of said credit card, or card with substantially the same dimensions as a credit card. The second connection element can comprise the male part of a razor head connector of a known construction. It will be appreciated that there are many known connectors for razor heads, and the invention can work with any of them.

The invention also includes a credit card with a connector for a razor head integrally formed therein.

Therefore, according to a second aspect of the present invention a handle for a wet shave razor has substantially the same dimensions as a credit card, and is provided with a connection means at a first end thereof adapted to releasably connect to a razor head with which the handle is used.

Thus, the second aspect of the invention provides a handle for a wet shave razor with dimensions which allow it to be carried in a wallet. In addition, as the handle is the size and shape of a credit card it can be adapted to perform any of the known functions of a credit card. For example it can carry a chip, it can have a swipe band, or it can carry functional indicia such as proof of identity or useful numbers.

In addition, advertisers could provide such handles in order to promote a particular message, product or service, and as above this would allow such information to be seen when shaving, which is traditionally not a time when advertising has had any penetration.

### BRIEF DESCRIPTION OF THE DRAWINGS

The invention can be performed in various ways, but two embodiments will now be described by way of example and with reference to the accompanying drawings in which:

FIG. 1 is a perspective view of a connector according to the first aspect of the present invention;

FIG. 2 is an exploded perspective view of the connector as shown in FIG. 1 in an in use configuration;

FIG. 3 is a perspective view of the connector as shown in FIG. 1 in an in use configuration; and

FIG. 4 is an exploded perspective view of a handle according to the second aspect of the present invention in an in use configuration.

### DETAILED DESCRIPTION

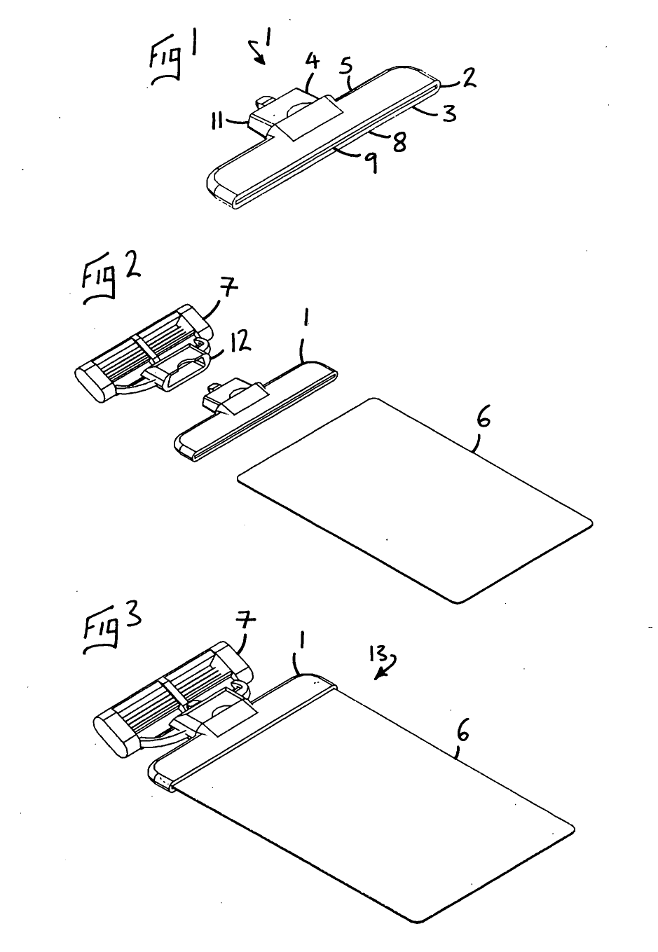

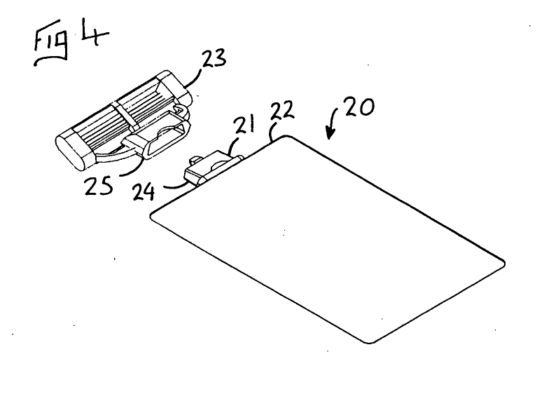

As shown in FIG. 1 a connector 1 is provided with a first connection means 2 on a first side 3 and a second connection means 4 on a second side 5. The first connection means 2 is adapted to releasably connect to a credit card 6 with which the connector 1 is used, as shown in FIGS. 2 and 3. The second connection means 4 is adapted to releasably connect to a razor head 7 with which the connector 1 is used, as shown in FIGS. 2 and 3.

The first connection means 2 comprises a body 8 with an elongate slot 9 formed therein, which is adapted to receive a first end 10 of said credit card, as shown in the Figures.

The second connection means 4 comprises the male part 11 of a razor head connector of a known construction. The female part 12 of the connector is provided on the razor head 7, and the two parts go together as shown in FIG. 3.

Thus, the connector 1 facilitates the quick and easy creation of a functional wet shave razor 13. Thus, as described above the connector 1 allows a user to create such a device only using a razor head 7, and a credit card 6 which they might carry in their wallet. Thus, the need to carry a known wet shave razor handle is eliminated.

The credit card 6 is shown in the Figures as blank, but it will be appreciated that any of the known indicia could be carried thereon, and in addition, indicia intended specifically for the purpose could be carried thereon, for example targeted advertising. As such, the invention allows for advertising to be viewed when shaving.

The embodiment shown in FIGS. 1 to 3 shows a particular construction of the male 11 and female 12 parts of a razor head connector. It will be appreciated that there are many known variations of such items, and the invention is not limited to any one.

As described above the invention also includes a credit card with a connector for a razor head integrally formed therein, and such a device is shown in FIG. 4.

In FIG. 4 a handle 20 for a razor has substantially the same dimensions as a credit card, and is provided with a connection means 21 at a first end 22 thereof adapted to releasably connect to a razor head 23 with which the handle 20 is used.

The connection means 21 comprises the male part 24 of a razor head connector of a known construction. The female part 25 of the connector is provided on the razor head 23.

Thus, the handle 20 can be carried in a wallet adapted to carry credit cards, and it can facilitate the quick and easy creation of a functional wet shave razor.

Again, the handle 20 is shown in FIG. 4 as blank, but it will be appreciated that any of the known indicia could be carried thereon, and in addition, indicia intended specifically for the purpose, for example targeted advertising.

In addition, as the handle 20 is the size and shape of a credit card it can be adapted to perform any of the known functions of a credit card. For example it can carry a chip, it can have a swipe band, or it can carry functional indicia such as proof of identity or useful numbers. It will be appreciated that the manner in which such items are carried by a credit card are well known, and as such they are not further described here.

Thus, a connector and a handle are provided which alleviate the problem of having to carry a conventional razor handle when one travels, or even having to own one at all. Further a wet shave razor is provided with a broad and flat handle which can be readily manipulated by the infirm or the disabled. In addition, technical means are provided to allow targeted advertising to penetrate the arena of shaving

Although the invention herein has been described with reference to particular embodiments, it is to be understood that these embodiments are merely illustrative of the principles and applications of the present invention. It is therefore to be understood that numerous modifications may be made to the illustrative embodiments and that other arrangements may be devised without departing from the spirit and scope of the present invention as defined by the appended claims.

1. A connector comprising a first connection means on a first side and a second connection means on a second side, in which the first connection means is adapted to releasably connect to a credit card, or a card with substantially the same dimensions as a credit card, with which the connector is used, and in which the second connection means is adapted to releasably connect to a razor head with which the connector is used.

2. The connector as claimed in claim 1 in which the first connection means comprises a body with an elongate slot formed therein, which slot is adapted to receive a first end of said credit card, or card with substantially the same dimensions as a credit card

3. The connector as claimed in claim 2 in which the second connection means comprises the male part of a razor head connector.

4. A razor handle comprising a handle having substantially the same dimensions as a credit card, and is provided with a connection means at a first end thereof adapted to releasably connect to a razor head with which the handle is used.

5. The connector as set forth in claim 1 wherein the card forms a handle for the razor.

6. The connector as set forth in claim 3 wherein the razor has a female part for releasably receiving the male part of the second connection means.
